(19) United States
(12) Patent Application Publication
(10) Pub. No.: US 2003/0093540 A1
(43) Pub. Date: May 15, 2003

(54) Proxy network layer protocol support in a wireless communication network

(76) Inventor: Marcello Lioy, San Diego, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 10/003,016

(22) Filed: Nov. 14, 2001

(51) Int. Cl. G06F 15/16; H04B 7/00

(52) U.S. Cl. 709/230; 709/236; 370/310

(57) ABSTRACT

A method and system for supporting a network layer protocol in a wireless communication network are presented. A network element, such as a packet data serving node (PDSN), receives, from a mobile device, a first packet of a receive packet stream. If the first packet conforms to a first predetermined protocol, then at least a portion of the first packet is forwarded to a router that supports the first predetermined protocol. The network element receives a second packet forwarded by the router. If the second packet conforms to the first predetermined network layer protocol, then at least a portion of the second packet is transmitted in a transmit packet stream. As such, the network element need not natively support the first predetermined protocol.

### BACKGROUND OF THE INVENTION

1. Field of the Invention

This invention relates generally to the field of wireless communications. More particularly, this invention relates to a novel method and system for supporting a network layer protocol in a network element of a wireless communication network.

2. Description of Related Art

Recent innovations in wireless communication and computer-related technologies, as well as the unprecedented growth of Internet subscribers, have paved the way for mobile computing. In fact, the popularity of mobile computing has placed greater demands on the current Internet infrastructure to provide mobile users with more support. A crucial part of meeting these demands and providing users with the necessary support is the use of Code Division Multiple Access (CDMA) technology in wireless communications systems.

CDMA is a digital radio-frequency (RF) channelization technique first defined in the Telecommunications Industry Association/Electronics Industries Association Interim Standard-95 (TIA/EIA IS-95), entitled “MOBILE STATION-BASE STATION COMPATIBILITY STANDARD FOR DUAL-MODE WIDEBAND SPREAD SPECTRUM CELLULAR SYSTEM,” published in July 1993 and herein incorporated by reference. Recently promulgated CDMA standards include TIA/EIA/IS-835-A, entitled “CDMA2000 WIRELESS IP NETWORK STANDARD,” published in May 2001 and herein incorporated by reference; TIA/EIA/IS-856, entitled “CDMA2000, HIGH RATE PACKET DATA AIR INTERFACE SPECIFICATION,” published in November 2000 and herein incorporated by reference; TIA/EIA/IS-2000.1-A, entitled “INTRODUCTION TO CDMA2000 STANDARD FOR SPREAD SPECTRUM SYSTEMS,” published in March 2000 and herein incorporated by reference; and TIA/EIA/IS-707-A, entitled “DATA SERVICE OPTIONS FOR WIDEBAND SPREAD SPECTRUM SYSTEMS,” published in April 1999 and herein incorporated by reference. TIA/EIA/IS-856 is also known as 1xEV. Wireless communications systems employing CDMA technology assign a unique code to communication signals and spread these communication signals across a common (wideband) spread spectrum bandwidth.

Other support is made possible by applying various well-known protocols to control, manage, or otherwise facilitate different aspects of wireless communications. For example, the lifeblood of the Internet infrastructure, the Internet Protocol (IP), has been incorporated in many wireless communication services to accommodate packet-oriented services. The IP protocol is a network layer protocol that encapsulates data into IP packets for transmission. In particular, the IP protocol specifies the addressing and routing of packets (datagrams) between host computers.

Version 4 of the IP protocol (“IPv4”) is defined in Request For Comments 791 (RFC 791) entitled “INTERNET PROTOCOL DARPA INTERNET PROGRAM PROTOCOL SPECIFICATION,” published September 1981, and herein incorporated by reference. Although the most widely used version of the IP protocol, IPv4 has a number of limitations, including its provision of a relatively limited number of network addresses, which uniquely define all devices accessing the Internet. IP Version 6 (“IPv6”), the “next generation” IP protocol, has been designed to replace IPv4 and is defined in RFC 2460, “INTERNET PROTOCOL, VERSION 6 (IPV6) SPECIFICATION,” published December 1998, and herein incorporated by reference. IPv6 mitigates some of the limitations of IPv4, including the limited number of available IPv4 addresses. Additionally, IPv6 improves upon IPv4 in numerous respects, such as routing and network autoconfiguration schemes. Herein, the term “IP protocol” is used where a concept is applicable to both IPv4 and IPv6. For version-specific concepts, the terms IPv4 and IPv6 are used.

IPv6 is expected to eventually replace IPv4. However, the two protocols will likely coexist for some time as the world transitions to IPv6. Most applications currently in use, whether for personal computers (PCs) or mobile devices, are built upon IPv4 exclusively, and it is likely that many of these devices will not or cannot be modified to support IPv6. Application support for IPv6 will likely emerge gradually.

Differences exist between the handling and operations of IPv4 and IPv6 protocols. Given the near-term coexistence of IPv4 and IPv6, tunneling approaches have been proposed to support the compatibility of IPv4 and IPv6. In accordance with a tunneling approach, two networks supporting the same version of a protocol can communicate even if they are separated by a network that does not support that version of the protocol. This is achieved by encapsulating the datagrams of the unsupported protocol inside datagrams of the protocol supported by the intermediary network.

In the case of a wireless network, the packets conforming to a protocol unsupported by a packet data serving node (PDSN) are encapsulated within packets conforming to a protocol supported thereby. The encapsulated packets are sent by the mobile device to the PDSN, which may then forward all or a portion of the packets to a router that does support the protocol unsupported by the PDSN. In order to support tunneling, however, mobile devices may require various modifications to their existing configurations. Such modifications increase the complexity and cost of mobile devices. Moreover, tunneling operations may result in the inefficient use of processing resources, as well as a decrease in data throughput.

Another well-known protocol incorporated in wireless communications systems is the Point-to-Point Protocol (PPP) protocol, which provides, inter alia, Internet access. The PPP protocol is described in detail in Request for Comments 1661 (RFC 1661), entitled “THE POINT-TO-POINT PROTOCOL (PPP),” published July 1994 and herein incorporated by reference.

Essentially, the PPP protocol specifies a method for transporting multi-protocol datagrams over point-to-point links and contains three main components: a method of encapsulating multi-protocol datagrams; a Link Control Protocol (LCP) for establishing, configuring, and testing a data link connection; and a family of Network Control Protocols (NCPs) for establishing and configuring different network layer protocols.

The PPP protocol supports multiplexing and demultiplexing of datagrams conforming to multiple protocols. Specifically, PPP encapsulation is employed to distinguish among multi-protocol datagrams. Each encapsulated frame includes, in addition to an Information field and a Padding field, a Protocol field whose value (protocol ID) identifies the datagram encapsulated in the Information field of the packet. The structure of this field may be 8 or 16 bits in length. Frames received which do not comply with associated addressing rules must be treated as having an unrecognized protocol.

### SUMMARY OF THE INVENTION

Systems and methods consistent with the principles of the present invention, as embodied and broadly described herein, provide for a novel method and system capable of efficiently supporting a network layer protocol in a wireless communications system, regardless of whether the communications system natively supports the protocol or variations thereof. In one embodiment, such a method and system, as presented herein, involves a network element that receives, from a mobile device, a first packet of a receive packet stream. When the first packet conforms to a first predetermined protocol that is not supported by the network element, then at least a portion of the first packet is forwarded to a router that supports the first predetermined protocol. The network element receives a second packet forwarded by the router. When the second packet conforms to the first predetermined network layer protocol, then at least a portion of the second packet is transmitted in a transmit packet stream. As such, the network element need not natively support the first predetermined protocol.

### BRIEF DESCRIPTION OF THE DRAWINGS

FIG. 1 illustrates a wireless communications system architecture.

FIG. 2 schematically describes the protocol stacks of a wireless communications system according to an embodiment of the present invention.

FIG. 3 is a high-level block diagram of a system according to an embodiment of the present invention.

FIG. 4 schematically describes the protocol stacks of a wireless communications system according to an embodiment of the present invention.

FIG. 5 is a high-level block diagram of a system according to an embodiment of the present invention.

FIG. 6 schematically describes the protocol stacks of a wireless communications system according to an embodiment of the present invention.

FIG. 7 is a high-level block diagram of a system according to an embodiment of the present invention.

FIGS. 8A and 8B are high-level flow diagrams of processes according to embodiments of the present invention.

### DETAILED DESCRIPTION OF THE INVENTION

The following detailed description refers to the accompanying drawings that illustrate embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volitile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

Embodiments of the present invention provide a method and system for a network element in a wireless communication network to support a network layer protocol. A network element, such as a packet data serving node (PDSN), receives a packet in a receive packet stream. The receive packet stream may have originated from a terminal equipment, such as a mobile station. If the packet conforms to a particular network layer protocol, the network element forwards the packet to a router that is capable of processing such packets. Similarly, packets intended for a terminal equipment may be forwarded by a router to the network element. The network element may then transmit the packets in a transmit packet stream.

As such, the network element may transparently support a protocol from a user's perspective even if the network element includes no native support for the protocol.

In some embodiments, the network element may process a packet before forwarding it to a router or to the mobile station. For instance, the network element may unframe or apply header compression and decompression algorithms to the packet.

Embodiments of the present invention may be employed in conjunction with various protocols, such as, for example, the IPv4 and IPv6 protocols.

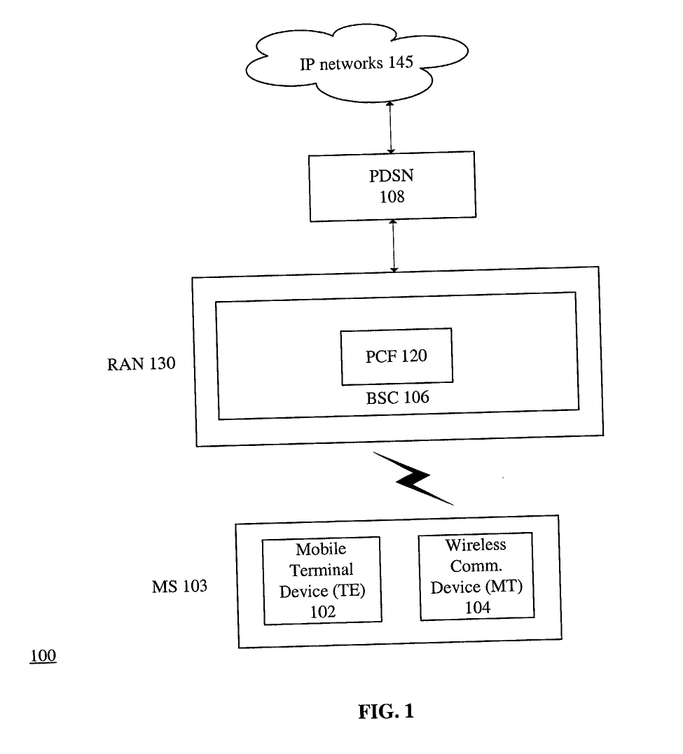

FIG. 1 illustrates a wireless communications system architecture 100 in which mobile terminal equipment, TE device 102 (e.g., a mobile terminal, laptop, or palmtop computer), wirelessly connects to a radio access network (RAN) 130 via a wireless communications device, MT 104. Practitioners will readily appreciate that these elements, and their interfaces, may be modified, augmented, or subjected to various standards known in the art, without limiting their scope or function. TE device 102 and MT device 104, which are electronically coupled, may be integrated into a single unit or may be separated out as in an installed mobile phone unit in which a laptop is TE device 102 and the transceiver is MT device 104. The combination of TE device 102 and MT device 104, whether integrated or separate, is also referred to as a mobile node, and is denoted in FIG. 1 as mobile station (MS) 103.

RAN 130 includes a base station controller (BSC) 106 and associated base station transceivers (BSTs) (not shown). BSC 106 includes a packet control function (PCF) 120. PCF 120 acts as an interface to a packet data serving node (PDSN), such as PDSN 108. PDSN 108 is a router that acts as an interface to IP networks 145, such as the Internet and intranets.

A. First Embodiment

According to a first embodiment of the present invention, a PDSN that natively supports only IPv6 can also support IPv4 by forwarding IPv4 packets to, and receiving IPv4 packets from, a router that supports IPv4. The PDSN may unframe and apply header compression or decompression algorithms to such IPv4 packets.

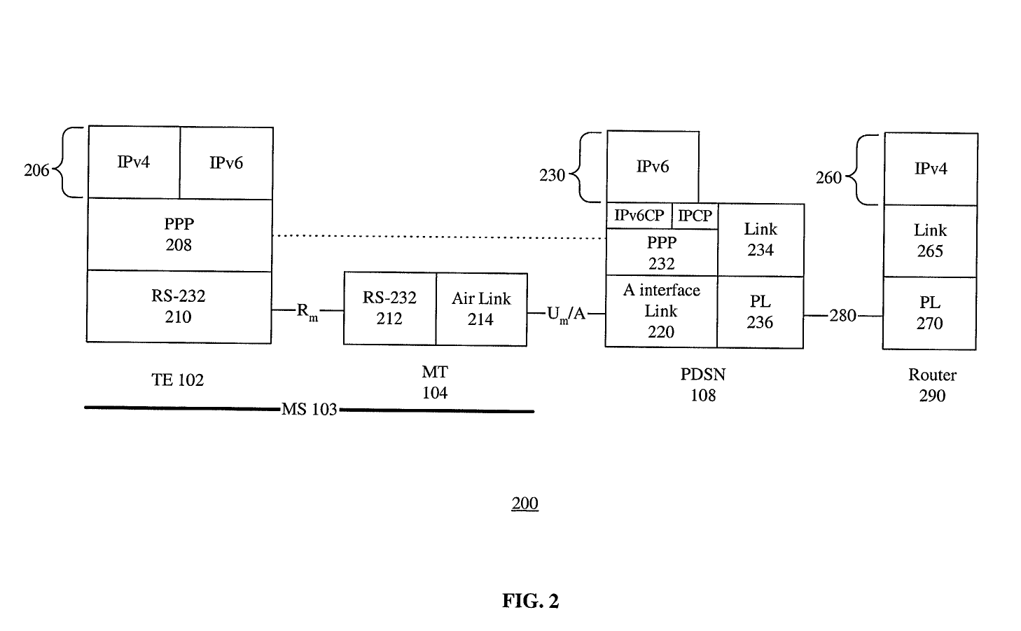

FIG. 2 schematically describes the protocol stacks of a wireless communications system 200 according to an embodiment of the present invention. Protocol stacks of each entity are shown in conventional vertical format. System 200 conforms to the Relay Model of the IS-707 standard. In other embodiments, system 200 may conform to other models, such as the Network Model or the MT0 Model of the IS-707 standard. In the Network Model, MT device 104 is responsible for unframing any received PPP packets and reframing them before forwarding them to their final destination as well as providing mobility management and network address management. In the MT0 model, a protocol stack of MT device 104 is used to support applications running on MT device 104 itself.

Consistent with the Relay Model, system 200 includes TE device 102, MT device 104, PDSN 108, and a router 290. The TE protocol stack of TE device 102 is illustrated as being logically connected to the PDSN 108 protocol stack via an Rₘ interface between TE device 102 and MT device 104, and a Uₘ/A interface between MT device 104 and PDSN 108. The PDSN 108 protocol stack is illustrated as being logically connected to the router 290 protocol stack over a link 280.

TE device 102 includes network layer protocols 206. In the embodiment shown, TE device 102 supports both the IPv4 and IPv6 network layer protocols. TE device 102 also includes link layer protocols 208. In particular, TE device 102 supports PPP protocol 208.

TE device 102 includes relay layer protocols 210 to allow transmission of packets, encoded by PPP layer 208, across the Rₘ interface to MT device 104 using an applicable protocol. An exemplary relay layer protocol is the TIA/EIA 232-F protocol. Associated RS-232 interfaces 210, 212 in TE device 102 and MT device 104, respectively, are shown in FIG. 2. The TIA/EIA-232-F standard is defined in “INTERFACE BETWEEN DATA TERMINAL EQUIPMENT AND DATA CIRCUIT-TERMINATING EQUIPMENT EMPLOYING SERIAL BINARY DATA INTERCHANGE,” published in October 1997 and herein incorporated by reference. It is to be understood that other standards or protocols known to artisans of ordinary skill in the art may be used to define the transmission across the Rₘ interface. For example, other applicable Rₘ interface standards may include the “UNIVERSAL SERIAL BUS (USB) SPECIFICATION, Revision 1.1,” published in September 1998, and the “BLUETOOTH SPECIFICATION VERSION 1.0A CORE, published in July 1999, both incorporated by reference.

MT device 104 includes an air link 214, which serves to connect MT device 104 to an A interface link 220 in PDSN 108 over the Uₘ/A interface. RAN 130 is not explicitly shown in system 200. RAN 130 bridges the air link and the A interface to allow data to flow between MT device 104 and PDSN 108.

Air link 214 may employ the Radio Link Protocol (RLP) and the IS-856, IS-2000, or IS-95 protocols, for example, to transmit packet-encapsulated PPP frames to PDSN 108 over the Uₘ/A interface. A version of the RLP protocol is defined in the IS-707.2 standard, entitled “DATA SERVICE OPTIONS FOR WIDEBAND SPREAD SPECTRUM SYSTEMS: RADIO LINK PROTOCOL,” published in February 1998 and herein incorporated by reference. A version of the RLP protocol for IS-856 (1xEV) is defined in TIA/EIA-136-310-A-1, entitled “TDMA THIRD GENERATION WIRELESS-RADIO LINK PROTOCOL-1, ADDENDUM 1,” published in June 2001 and herein incorporated by reference. The IS-856, IS-2000, and IS-95 protocols are defined in the standards identified above. Other standards may be employed by artisans of ordinary skill.

PDSN 108 includes network layer protocols 230. In the embodiment shown, PDSN 108 natively supports the IPv6 network layer protocol, IPv6CP, and header compression/decompression algorithms. Additionally, PDSN 108 supports Van Jacobson IPv4 header compression through the IPCP protocol stack (described below). PDSN 108 also includes data link layer protocols 232. In particular, PDSN 108 supports PPP protocol 232. PDSN also includes an A interface link 220, a physical layer (PL) 236, and a link layer 234.

A interface link 220 receives packets from MT device 104 over the Uₘ/A interface provided by RAN 130 and transfers the received packets to PPP layer 232. PPP layer 232 then unframes the received packets and transfers them to the network layer protocol 230, which in turn either passes them to upper layer protocols (not shown) or forwards them to their final destination.

Router 290 includes a network layer protocol 260, a link layer 265, and a physical layer 270. In the embodiment shown in FIG. 2, router 290 supports the IPv4 network layer protocol. A physical layer (PL) 236 of PDSN 108 is operatively coupled to a physical layer 270 of router 290. As such, router 290 may provide PDSN 108 with connectivity to various networks, such as the Internet or intranets. In some embodiments, router 290 may be operated by an Internet service provider (ISP).

The configuring, enabling, and disabling of the network layer protocol modules 206, 230 on both ends of the PPP link is provided by control protocols. Specifically, for IPv4, the Internet Protocol Control Protocol (IPCP) is employed. IPCP is a part of a family of network control protocols included in the PPP protocol and described in Request for Comments (RFC) 1332, “THE PPP INTERNET PROTOCOL CONTROL PROTOCOL (IPCP),” published in May 1992 and herein incorporated by reference.

IPCP utilizes configuration request messages to negotiate various configuration options. One such option is the IP Header Compression Protocol Option. When enabled, this option generally employs the Van Jacobson (VJ) compression methodology for compressing the TCP/IP headers in a PPP packet. The Van Jacobson compression methodology improves the efficiency of a protocol by reducing the overhead in the packet headers and is described in RFC 1144 entitled, “COMPRESSING TCP/IP HEADERS FOR LOW-SPEED SERIAL LINKS,” published in February 1990 and herein incorporated by reference. The Van Jacobson compression methodology is a compression algorithm that relies on knowledge of the fields in the TCP/IP headers to determine how they are likely to change from packet to packet. IPv4 packets may be of type straight IPv4, VJ compressed, and VJ uncompressed.

The IPv6 analogue of IPCP is the IPv6 Control Protocol (IPv6CP). IPv6CP is described in Request for Comments (RFC) 2472, “IP VERSION 6 OVER PPP,” published in December 1998 and herein incorporated by reference. An IPv6-Compression-Protocol Configuration Option provides a way to negotiate the use of a specific IPv6 packet compression protocol. The IPv6-Compression-Protocol Configuration Option is used to indicate the ability to receive compressed packets. As stated above, PDSN 108 includes support for IPv6CP.

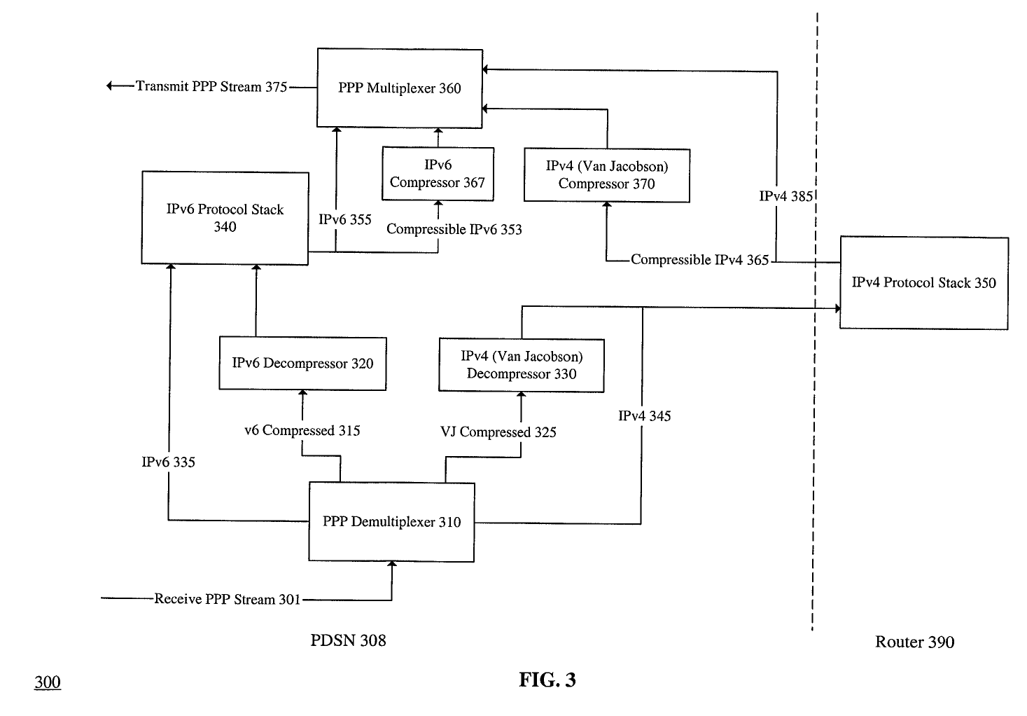

FIG. 3 is a high-level block diagram of a system 300 for supporting a network layer protocol according to an embodiment of the present invention. Protocol stacks of system 300 may be the same as those of system 200 described above. System 300 includes a PPP multiplexer 360, PPP demultiplexer 310, IPv6 decompressor 320, IPv4 (Van Jacobson) decompressor 330, IPv6 protocol stack 340, IPv6 compressor 367, IPv4 (Van Jacobson) compressor 370, and IPv4 protocol stack 350. Modules to the left of the dashed line reside in a PDSN 308 and modules to the right thereof reside in a router 390.

Thus, in the embodiment shown in FIG. 3, PDSN 308 includes native support for the IPv6 protocol, IPv6CP support, and IPCP support. Accordingly, PDSN 308 may unframe and apply header compression and decompression algorithms to IPv4 packets. Router 390 natively supports the IPv4 protocol and includes IPCP support.

PPP demultiplexer 310 receives as input a receive PPP stream 301 originating at an external device, such as MS 103 in FIG. 1. In an exemplary implementation, packets of receive PPP stream 301 may conform to either the IPv4 or IPv6 protocols. PPP demultiplexer 310 forwards received packets to appropriate modules in PDSN 308.

In particular, PPP demultiplexer 310 determines to which protocol packets in receive PPP stream 301 conform and forwards packets to other modules accordingly. In one embodiment, PPP demultiplexer 310 examines the Protocol field of each PPP packet. Based on the protocol ID of each packet, PPP demultiplexer 310 forwards the packet.

If the protocol ID of a packet corresponds to the IPv6 protocol (straight IPv6), then PPP demultiplexer 310 forwards such an IPv6 packet 335 to IPv6 protocol stack 340. If the protocol ID of a packet corresponds to an IPv6 compressed protocol, then PPP demultiplexer 310 forwards such an IPv6 compressed packet 315 to IPv6 decompressor 320. If the protocol ID of a packet corresponds to an IPv4 compressed (VJ compressed) protocol, then PPP demultiplexer 310 forwards such a VJ compressed packet 325 to IPv4 decompressor 330. If the protocol ID of a packet corresponds to the IPv4 protocol, then PPP demultiplexer 310 forwards such an IPv4 packet 345 to IPv4 protocol stack 350 in router 390.

IPv6 decompressor 320 operates upon IPv6 compressed packets 315 in accordance with applicable decompression algorithms and forwards the resulting decompressed packets to IPv6 protocol stack 340.

IPv6 protocol stack 340 operates upon IPv6 packets 335 and decompressed IPv6 packets forwarded by IPv6 decompressor 320. IPv6 protocol stack 340 also forwards IPv6 packets 355 to PPP multiplexer 360, and compressible IPv6 packets 353 to IPv6 compressor 367.

IPv6 compressor 367 receives compressible IPv6 packets 353 from IPv6 protocol stack 340. IPv6 compressor 367 compresses such packets and forwards them to PPP multiplexer 360.

IPv4 decompressor 330 operates upon VJ compressed packets 325 and forwards the resulting decompressed packets to IPv4 protocol stack 350 in router 390.

IPv4 protocol stack 350 in router 390 operates upon IPv4 packets 345 and decompressed IPv4 packets forwarded by IPv4 decompressor 330. IPv4 protocol stack 350 also forwards IPv4 packets 385 to PPP multiplexer 360, and forwards compressible IPv4 packets 365 to IPv4 compressor 370.

IPv4 compressor 370 in PDSN 308 receives compressible IPv4 packets 365 from IPv4 protocol stack 350 in router 390. IPv4 compressor 370 compresses such packets and forwards them to PPP multiplexer 360.

PPP multiplexer 360 receives as input packets conforming to various protocols. For instance, PPP multiplexer 360 receives IPv6 packets 355 from IPv6 protocol stack 355; IPv6 compressed packets forwarded by IPv6 compressor 367; IPv4 packets 385 from IPv4 protocol stack 350 in router 390; and IPv4 compressed packets forwarded by IPv4 compressor 370. PPP multiplexer 360 outputs a transmit PPP stream 375 containing packets inputted to PPP multiplexor 360.

In an exemplary implementation, packets arriving from router 390 are routed to a specific interface on PDSN 308 that is mapped to a corresponding PPP instance. Because it is known that packets arriving from this interface only are IPv4 packets, PPP multiplexes the packets correctly in transmit PPP stream 375. Specifically, packets are mapped on the basis of the protocol ID conveyed with the packet. Compression mechanisms in PDSN 308 place the correct protocol ID in a packet. In particular, if the packet is compressed, it is given the protocol ID of a compressed TCP packet. If the packet stream is to be compressed in the future, it is given the TCP uncompressed protocol ID. Otherwise, the packet is given only the IP protocol ID.

As such, according to an embodiment of the present invention, PDSN 308, through connectivity with router 390, provides full support for both the IPv6 and IPv4 protocols without natively including an IPv4 protocol stack.

B. Second Embodiment

According to a second embodiment of the present invention, a PDSN that natively supports only IPv4 can also support IPv6 by forwarding IPv6 packets to, and receiving IPv6 packets from, a router that supports IPv6. The PDSN may unframe and apply header compression and decompression algorithms to such IPv6 packets.

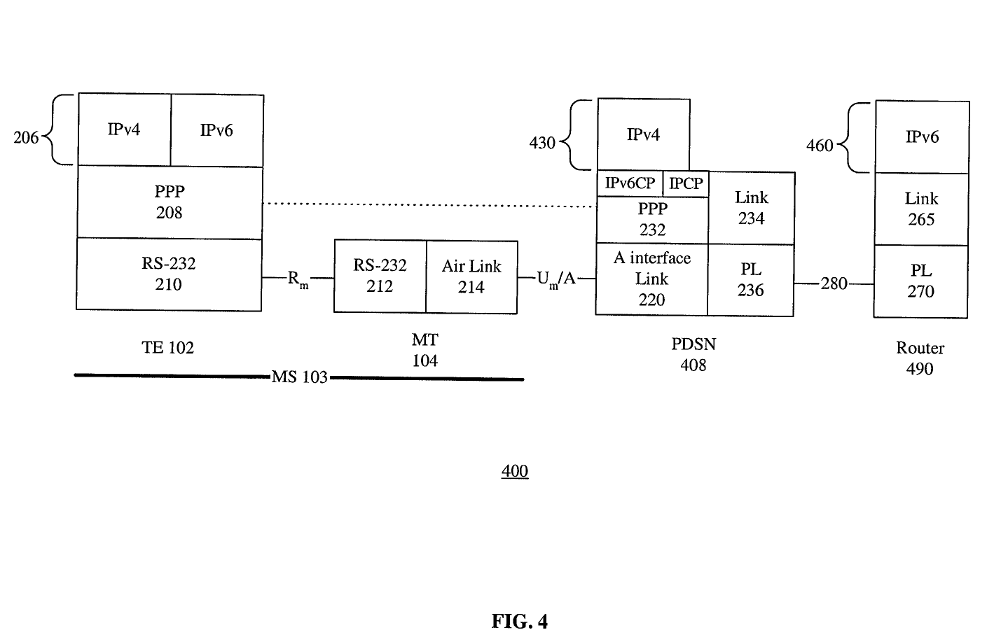

FIG. 4 schematically describes the protocol stacks of a wireless communications system 400 according to an embodiment of the present invention. System 400 includes TE device 102, MT device 104, a PDSN 408, and a router 490.

TE device 102 and MT device 104 are described above in connection with FIG. 2. Modules in PDSN 408 correspond to like-numbered modules in PDSN 108 in FIG. 2. PDSN 408 includes network layer protocols 430. In particular, PDSN 108 natively supports the IPv4 network layer protocol. Additionally, PDSN 408 supports IPv6CP and related compression algorithms. Modules in router 490 correspond to like-numbered modules in router 290 in FIG. 2. Router 490 includes a network layer protocol 460. In particular, router 490 supports the IPv6 network layer protocol.

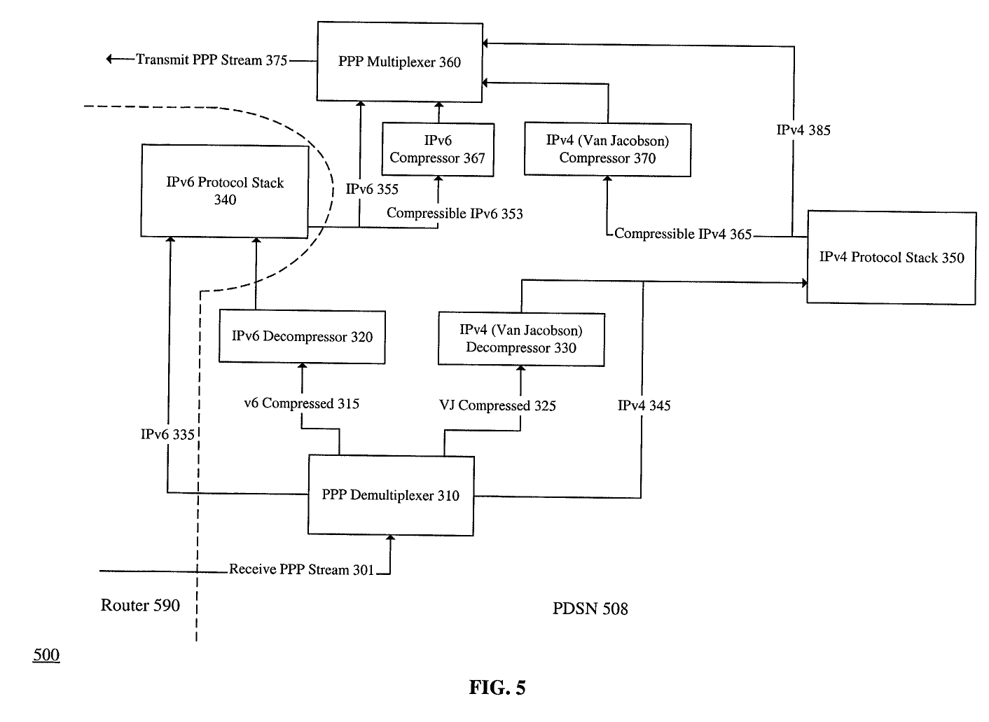

FIG. 5 is a high-level block diagram of a system 500 for supporting a network layer protocol according to an embodiment of the present invention. Protocol stacks of system 500 may be the same as those of system 400 described above. System 500 includes a PPP multiplexer 360, PPP demultiplexer 310, IPv6 decompressor 320, IPv4 (Van Jacobson) decompressor 330, IPv6 protocol stack 340, IPv6 compressor 367, IPv4 (Van Jacobson) compressor 370, and IPv4 protocol stack 350. Modules to the left of the dashed line reside in a router 590, and modules to the right thereof reside in a PDSN 508. IPv6 compressor 367 in PDSN 508 compresses compressible IPv6 packets 353 received from IPv6 protocol stack 340 in router 590 and forwards them to PPP multiplexer 360 for transmission. Modules in system 500 correspond to like-numbered modules in system 300. However, the locations of the modules differ as shown.

Thus, in the embodiment shown in FIG. 5, PDSN 508 includes native support for the IPv4 protocol, IPCP, and IPv6CP. Accordingly, PDSN 508 may unframe and apply header compression and decompression algorithms to IPv6 packets. Router 590 natively supports the IPv6 protocol.

More specifically, packets in receive PPP stream 301 are demultiplexed by PPP demultiplexer 310. IPv4 packets 345, VJ compressed packets 325, and IPv6 compressed packets 315 are sent to associated modules in PDSN 508. IPv6 packets are forwarded to IPv6 protocol stack 340 in router 590. After IPv6 decompressor 320 decompresses IPv6 compressed packets 315, IPv6 decompressor 320 forwards the decompressed packets to IPv6 protocol stack 340 in router 590. Because PDSN 508 natively supports IPv4, IPCP, and VJ compression, processing of associated packets remains in PDSN 508. PPP multiplexer 360 receives IPv6 packets 355 from router 590, and IPv6 compressed packets, IPv4 packets 385, and VJ compressed packets from modules in PDSN 508. PPP multiplexer 360 multiplexes such packets into transmit PPP stream 375.

As such, according to an embodiment of the present invention, PDSN 508, through connectivity with router 590, provides support for both the IPv6 and IPv4 protocols without natively including an IPv6 protocol stack.

C. Third Embodiment

According to a third embodiment of the present invention, a PDSN that natively supports only IPv6 can also support IPv4 by forwarding IPv4 packets to, and receiving IPv4 packets from, a router that supports IPv4. The PDSN does not unframe and apply header compression or decompression algorithms to IPv4 packets, but forwards entire IPv4 packets to the router for processing by the router.

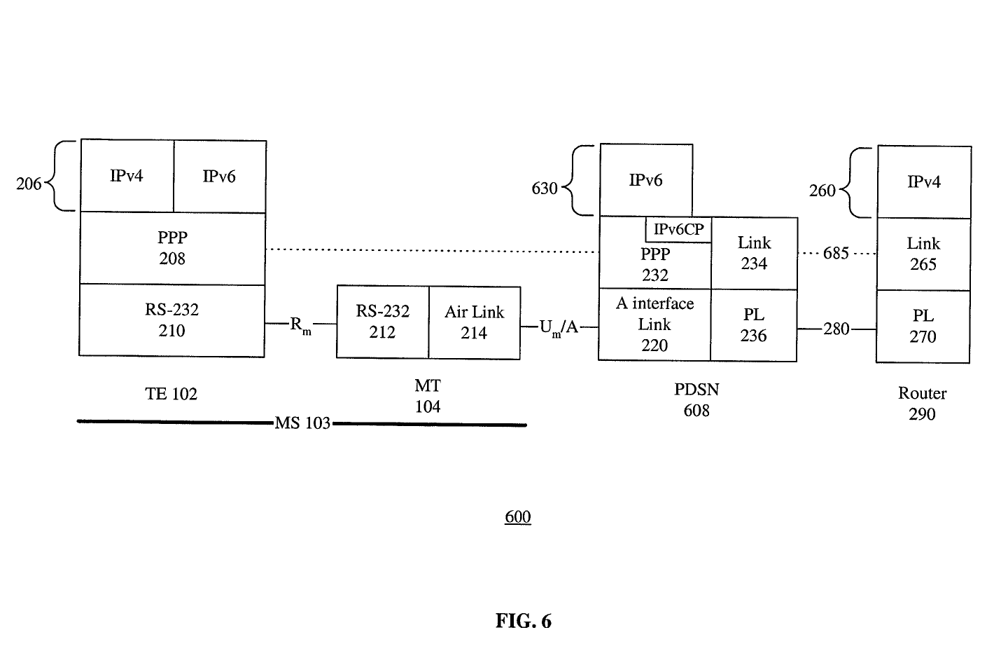

FIG. 6 schematically describes the protocol stacks of a wireless communications system 600 according to an embodiment of the present invention. System 600 includes TE device 102, MT device 104, a PDSN 608, and a router 290. Modules in FIG. 6 correspond to like-numbered modules in FIG. 2. PDSN 608 includes IPv6 support and IPv6CP support. PDSN 608 does not natively support IPv4, IPCP, or VJ compression and decompression. Logical connection 685 between link layers 234, 265 in PDSN 608 and router 290, respectively, is a conduit for PPP packets that contain either IPCP or FRAMED IPv4 packets.

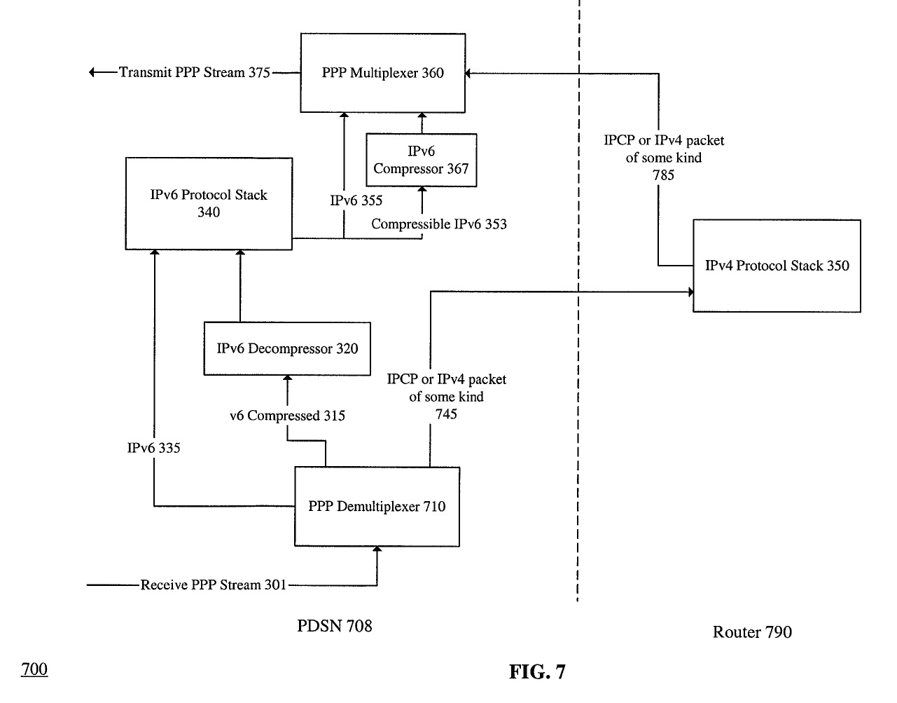

FIG. 7 is a high-level block diagram of a system 700 for supporting a network layer protocol according to an embodiment of the present invention. Protocol stacks of system 700 may be the same as those of system 600 described above. System 700 includes a PPP multiplexer 760, PPP demultiplexer 710, IPv6 decompressor 320, IPv6 protocol stack 340, IPv6 compressor 367, and IPv4 protocol stack 350. Modules to the left of the dashed line reside in a PDSN 708 and modules to the right thereof reside in a router 790. Thus, PDSN 708 includes native support for the IPv6 protocol and IPv6CP support. Router 290 natively supports the IPv4 protocol.

PPP demultiplexer 710 receives as input a receive PPP stream 301 originating at an external device, such as MS 103 in FIG. 1. In an exemplary implementation, packets of receive PPP stream 301 may conform to either the IPv4 or IPv6 protocols. PPP demultiplexer 710 forwards received packets to appropriate modules in PDSN 708.

In particular, PPP demultiplexer 710 determines to which protocol packets in receive PPP stream 301 conform and forwards packets to other modules accordingly. In one embodiment, PPP demultiplexer 710 examines the Protocol field of each PPP packet. Based on the protocol ID of each packet, PPP demultiplexer 710 forwards the packet.

If the protocol ID of a packet corresponds to the IPv6 protocol, then PPP demultiplexer 710 forwards such an IPv6 packet 335 to IPv6 protocol stack 340. If the protocol ID of a packet corresponds to an IPv6 compressed protocol, then PPP demultiplexer 710 forwards such an IPv6 compressed packet 315 to IPv6 decompressor 320. If the protocol ID of a packet corresponds to an IPCP protocol (e.g., VJ compressed) or the IPv4 protocol, then PPP demultiplexer 710 forwards, without unframing or applying compression algorithms thereon, such a packet to IPv4 protocol stack 350 in router 790.

IPv6 decompressor 320 operates upon IPv6 compressed packets 315 in accordance with applicable decompression algorithms and forwards the resulting decompressed packets to IPv6 protocol stack 340.

IPv6 protocol stack 340 operates upon IPv6 packets 335 and decompressed IPv6 packets forwarded by IPv6 decompressor 320. IPv6 protocol stack 340 also forwards IPv6 packets 355 to PPP multiplexer 360, and compressible IPv6 packets 353 to IPv6 compressor 367.

IPv6 compressor 367 receives compressible IPv6 packets 353 from IPv6 protocol stack 340. IPv6 compressor 367 compresses such packets and forwards them to PPP multiplexer 360.

IPv4 protocol stack 350 in router 790 operates upon IPv4 or IPCP packets 745 forwarded by PPP demultiplexer 710.

PPP multiplexer 760 receives as input packets conforming to various protocols. For instance, PPP multiplexer 760 receives IPv6 packets 355 from IPv6 protocol stack 340; IPv6 compressed packets forwarded by IPv6 compressor 367; and IPCP or IPv4 packets 785 from IPv4 protocol stack 350 in router 790. PPP multiplexer 760 outputs a transmit PPP stream 375 of the packets inputted to PPP multiplexer 760.

In an exemplary implementation, packets arriving from router 790 are routed to a specific interface on PDSN 708 that is mapped to a corresponding PPP instance. Because it is known that packets arriving from this interface only are IPv4 or IPCP packets, PPP multiplexes the packets correctly in transmit PPP stream 375 on the basis of the protocol ID conveyed with each packet.

As such, according to an embodiment of the present invention, PDSN 708, through connectivity with router 790, provides support for both the IPv6 and IPv4 protocols without natively including an IPv4 protocol stack or IPCP support.

It is to be appreciated that system 700 may non-natively support multiple protocols. For instance, upon determining that PDSN 708 is not configured to natively process a packet, PPP demultiplexer 710 may forward the packet to a predetermined location. A module at the predetermined location may process the forwarded packet. Moreover, PPP demultiplexer 710 need not identify the protocol of the packet, but simply may determine that the protocol ID of the packet represents a protocol which PDSN 708 is unequipped to process.

D. Process

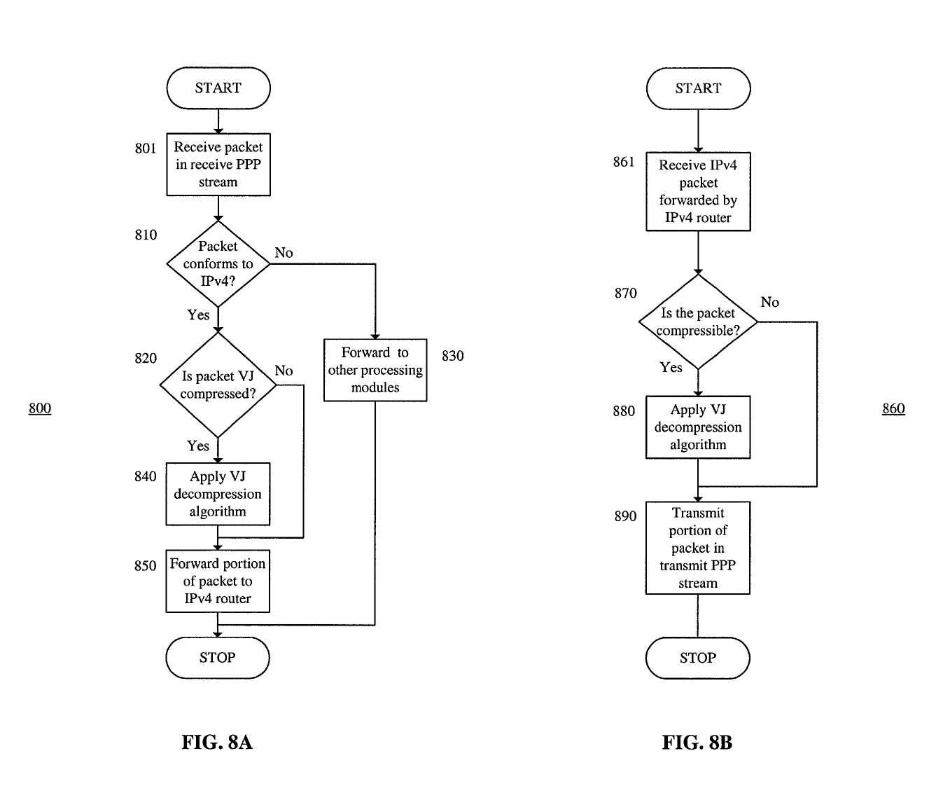

FIGS. 8A and 8B are high-level flow diagrams of processes 800 and 860 for supporting a network layer protocol according to embodiments of the present invention. It is to be noted that the processes of FIGS. 8A and 8B are related to the first embodiment presented above. However, the processes may be modified by artisans of ordinary skill to provide utility in other configurations.

In process 800 of FIG. 8A, a PDSN receives a packet that conforms to the IPv4 or IPv6 protocols. Specifically, in task 801, a PDSN receives a packet of a receive PPP stream. In task 810, the process ascertains whether the packet conforms to IPv4. If not, then other processing modules process the packet (task 830). For instance, the packet may conform to a protocol natively supported by the PDSN, such as IPv6, and the IPv6 protocol stack may process the packet.

If the packet does conform to IPv4, then in task 820, the process determines whether the packet is VJ compressed. If not, the packet is forwarded to an IPv4 router for processing (task 850). If the packet is VJ compressed, then a VJ decompression algorithm is applied to the packet in task 840. The decompressed packet is forwarded to the IPv4 router in task 850.

In process 860 of FIG. 8B, a PDSN receives, from a router, an IPv4 packet that is intended for a terminal device. Specifically, in task 861, the PDSN receives an IPv4 packet forwarded by an IPv4 router. In task 870, the process determines whether the packet is compressible. If not, the packet is transmitted in a transmit PPP stream to the terminal device (task 890). If the packet is compressible, then in task 880, a VJ compression algorithm is applied to the packet. The compressed packet is then transmitted in the transmit PPP stream in task 890.

The foregoing description of the preferred embodiments is provided to enable any person skilled in the art to make or use the present invention. Various modifications to these embodiments are possible, and the generic principles presented herein may be applied to other embodiments as well. For instance, in an embodiment related to the third embodiment, a PDSN includes native IPv4 support, but no support for IPv6 packets of any kind. A demultiplexer in such a PDSN may forward received IPv6 packets to a router for processing. In other embodiments, a PDSN may natively support protocols such as IPv4 and IPv6. However, if a protocol stack becomes corrupted or otherwise inoperative, the PDSN may forward associated packets to a router for processing until native support for the protocol in the PDSN is restored.

Further, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed is:

1. A method of supporting a network layer protocol in a network element of a wireless communication network, comprising:
receiving, by the network element, a first packet of a receive packet stream;
ascertaining whether the first packet conforms to a first predetermined network layer protocol; and
forwarding, at least in part in response to ascertaining that the first packet conforms to the first predetermined protocol, at least a portion of the first packet to a router, the router being configured to support the first predetermined protocol.

2. The method of claim 1, wherein the ascertaining involves examining a protocol identifier encapsulated within the first packet, the protocol identifier uniquely identifying a protocol to which the first packet conforms.

3. The method of claim 1, wherein the entire first packet is forwarded to the router.

4. The method of claim 1, wherein less than the entire first packet is forwarded to the router.

5. The method of claim 1, further comprising processing the first packet after the ascertaining and before the forwarding.

6. The method of claim 5, wherein the processing includes applying a decompression process to the first packet.

7. The method of claim 6, wherein the decompression process is applied in accordance with an Internet Protocol version 4 (IPv4) Van Jacobson decompression process.

8. The method of claim 6, wherein the decompression process is applied in accordance with an Internet Protocol version 6 (IPv6) decompression process.

9. The method of claim 1, wherein the receive packet stream comprises a Point-to-Point Protocol (PPP) stream.

10. The method of claim 1, wherein the network element includes substantially no native support for the first predetermined protocol.

11. The method of claim 1, wherein the network element includes one of compression support and decompression support for the first predetermined protocol.

12. The method of claim 1, wherein the network element is configured to natively support a second predetermined protocol.

13. The method of claim 12, wherein the second predetermined protocol comprises one of Internet Protocol, Version 4 (IPv4) and Internet Protocol, Version 6 (IPv6).

14. The method of claim 1, wherein the network element comprises a packet data serving node (PDSN).

15. The method of claim 1, wherein the receive packet stream originates at a terminal device, the terminal device comprising one of a mobile station and a personal computer (PC).

16. The method of claim 1, further comprising:
receiving, by the network element, a second packet forwarded by the router;
ascertaining whether the second packet conforms to the first predetermined network layer protocol; and
transmitting, in response to ascertaining that the second packet conforms to the first predetermined protocol, at least a portion of the second packet in a transmit packet stream.

17. The method of claim 16, wherein ascertaining whether the second packet conforms to the first predetermined network layer protocol involves routing the received second packet to a corresponding instance in the network element.

18. The method of claim 16, wherein the transmit packet stream is broadcast to a terminal device, the terminal device comprising one of a mobile station and a personal computer (PC).

19. A network element for supporting a network layer protocol in a wireless communication network, comprising:
a first receiver to receive a first packet of a receive packet stream;
a demultiplexer operatively coupled to the first receiver and configured to ascertain whether the first packet conforms to a first predetermined network layer protocol; and
a forwarding mechanism operatively coupled to the demultiplexer and configured to forward, at least in part in response to the demultiplexer ascertaining that the first packet conforms to the first predetermined protocol, at least a portion of the first packet to a router, the router being configured to support the first predetermined protocol.

20. The network element of claim 19, further comprising a processing mechanism operatively coupled to the demultiplexer and the forwarding mechanism, the processing mechanism being configured to process the first packet after the ascertaining and before the forwarding.

21. The network element of claim 19, wherein the processing mechanism is configured to apply a decompression process to the first packet.

22. The network element of claim 19, further comprising:
a second receiver to receive, by the network element, a second packet transmitted by the router;
a multiplexer operatively coupled to the second receiver and configured to ascertain whether the second packet conforms to the first predetermined network layer protocol; and
a transmitter operatively coupled to the multiplexer and configured to forward, in response to ascertaining that the second packet conforms to the first predetermined protocol, at least a portion of the second packet in a transmit packet stream.

23. The network element of claim 22, further comprising a second processing mechanism operatively coupled to the second receiver and the multiplexer, the second processing mechanism being configured to process the second packet after the receiving by the second receiver and before the ascertaining by the multiplexer.

24. The network element of claim 23, wherein the second processing mechanism is configured to apply a compression process to the second packet.

25. The network element of claim 19, wherein the network element includes substantially no native support for the first predetermined protocol.

26. The network element of claim 19, wherein the network element is configured to natively support a second predetermined protocol.

27. The network element of claim 26, wherein the second predetermined protocol comprises one of Internet Protocol, Version 4 (IPv4) and Internet Protocol, Version 6 (IPv6).

28. A computer-readable medium encoded with a plurality of processor-executable instructions for:
receiving, by a network element, a first packet of a receive packet stream;
ascertaining whether the first packet conforms to a first predetermined network layer protocol; and
forwarding, at least in part in response to ascertaining that the first packet conforms to the first predetermined protocol, at least a portion of the first packet to a router, the router being configured to support the first predetermined protocol.

29. The computer-readable medium of claim 28, wherein the ascertaining comprises examining a protocol identifier encapsulated within the first packet, the protocol identifier uniquely identifying a protocol to which the first packet conforms.

30. The computer-readable medium of claim 28, further comprising processor-executable instructions for:
receiving, by the network element, a second packet forwarded by the router;
ascertaining whether the second packet conforms to the first predetermined network layer protocol; and
transmitting, in response to ascertaining that the second packet conforms to the first predetermined protocol, at least a portion of the second packet in a transmit packet stream.
